(19) United States
(12) Patent Application Publication
(10) Pub. No.: US 2025/0066162 A1
(43) Pub. Date: Feb. 27, 2025

(54) CLEANING SYSTEM AND CLEANING METHOD FOR PASSENGER CONVEYOR SYSTEM

(71) Applicant: Otis Elevator Company, Farmington, CT (US)

(72) Inventors: Qing Cheng, Hangzhou (CN); Wenhai Yang, Hangzhou (CN); QiPing Huang, Hangzhou (CN)

(21) Appl. No.: 18/813,948

(22) Filed: Aug. 23, 2024

(30) Foreign Application Priority Data
Aug. 24, 2023 (CN) 202311077665.8

(51) Int. Cl. B66B 31/00; A47L 11/24; B66B 25/00

(52) U.S. Cl. CPC B66B 31/003; A47L 11/24; B66B 25/006

(57) ABSTRACT

A cleaning system and method for a passenger conveyor system. A cleaning system for a passenger conveyor includes a self-mobility cleaning device configured to move, in response to a cleaning request, to an entrance or exit of a conveying device designated by the cleaning request and to perform a cleaning operation on the designated conveying device.

### FOREIGN PRIORITY

This application claims priority to Chinese Patent Application No. 202311077665.8, filed Aug. 24, 2023, and all the benefits accruing therefrom under 35 U.S.C. § 119, the contents of which in its entirety are herein incorporated by reference.

### TECHNICAL FIELD OF INVENTION

The present application relates to elevator technology and, in particular, to a cleaning system and method for a passenger conveyor system.

### BACKGROUND OF THE INVENTION

Escalator is a personnel transportation equipment that is driven by a driving host through a chain to drive multiple pedals to make circular movement along a fixed track. With the rapid development of modern society and economy, escalators have been widely used in crowded places such as shopping malls, airports, railway stations and subway stations.

After long time operation of the escalator, there will be a lot of dirt on a maintenance cover and a floor plate. If manual cleaning is used, not only will the cost be high, but also the cleaning effect cannot be guaranteed.

### SUMMARY OF THE INVENTION

In accordance with an aspect of the present application, there is provided a cleaning system for a passenger conveyor system, the passenger conveyor system comprising one or more conveying devices, the conveying device being an escalator or a moving walkway, the cleaning system comprising: a self-mobility cleaning device configured to move, in response to a cleaning request, to an entrance or exit of the conveying device designated by the cleaning request and to perform a cleaning operation on the designated conveying device.

Optionally, in the above cleaning system, further comprising a controller associated with the conveying device.

Optionally, in the above cleaning system, the cleaning request is generated by the cleaning device or from one of a mobile terminal, the controller associated with the conveying device, and a console of the passenger conveyor system.

Optionally, in the above cleaning system, the cleaning request is generated in response to a user command or generated based on historical operational data of the cleaning device or the conveying device.

Optionally, in the above cleaning system, the cleaning device is further configured to instruct the controller to cause the designated conveying device to enter a cleaning mode after moving to the entrance or the exit of the conveying device designated by the cleaning request and before performing the cleaning operation on the designated conveying device, and to instruct the controller to cause the designated conveying device to exit the cleaning mode after completing the cleaning operation on the designated conveying device.

Optionally, in the above cleaning system, the controller associated with the designated conveying device is configured to cause the designated conveying device to enter the cleaning mode in response to an event triggering entry into the cleaning mode, and to cause the designated conveying device to exit the cleaning mode in response to an event triggering exit from the cleaning mode.

Optionally, in the above cleaning system, the cleaning device is a sweeping robot.

Optionally, in the above cleaning system, in the cleaning mode, a pedal of the conveying device moves at a set speed or an operation indicator of the conveying device indicates that the conveying device is in an out-of-service state.

Optionally, in the above cleaning system, the event triggering entry into the cleaning mode comprises the controller receiving a standby message sent by the cleaning device or a first sensor sensing signal triggered by the cleaning device arriving at the entrance or the exit of the designated conveying device, and the event triggering exit from the cleaning mode comprises the controller receiving a cleaning completion message sent by the cleaning device or a second sensor sensing signal triggered by the cleaning device leaving the entrance or the exit of the designated conveying device.

Optionally, in the above cleaning system, the first sensor sensing signal is indicative of a combination of obscured states of light at different heights at the entrance or the exit of the designated conveying device, and the second sensor sensing signal is indicative of a change in the light from an obscured state to an unobscured state at the entrance or the exit of the designated conveying device.

Optionally, in the above cleaning system, the cleaning device comprises: a first wireless communication unit configured to communicate with one of the mobile terminal, the controller and the console; a moving mechanism; a first processor coupled with the first wireless communication unit, configured to: instruct the moving mechanism to transport the cleaning device to the conveying device designated by the cleaning request in response to the cleaning request generated by the first processor or received via the first wireless communication unit; cause the designated conveying device to enter the cleaning mode by sending the standby message to the controller associated with the designated conveying device via the first wireless communication unit before performing the cleaning operation on the designated conveying device; cause the designated conveying device to exit the cleaning mode by sending the cleaning completion message to the controller associated with the designated conveying device via the first wireless communication unit after completing the cleaning operation on the designated conveying device.

Optionally, in the above cleaning system, a movement of the moving mechanism is based on navigation information or user control command.

Optionally, in the above cleaning system, the operation of the first processor sending the standby message comprises: determining whether the conveying device at a current location of the cleaning device is the conveying device designated by the cleaning request by scanning a device identification attached to or near the conveying device; sending the standby message if it is the conveying device designated by the cleaning request, the standby message containing the device identification of the designated conveying device.

Optionally, in the above cleaning system, the controller comprises: a second wireless communication unit configured to communicate with the cleaning device; a memory; a second processor coupled with the memory and the second wireless communication unit; and a computer program stored on the memory and capable of running on the second processor, the operation of which results in the following operations:
causing the conveying device to enter the cleaning mode when the standby message or the first sensor sensing signal is received via the second wireless communication unit; and causing the conveying device to exit the cleaning mode when the cleaning completion message or the second sensor sensing signal is received via the second wireless communication unit.

In accordance with another aspect of the present application, there is provided a cleaning device for a passenger conveyor system, the passenger conveyor system comprising one or more conveying devices, the conveying device being an escalator or a moving walkway, the cleaning device comprising: a wireless communication unit; a moving mechanism; a cleaning mechanism; a processor coupled with the wireless communication unit, configured to: instruct the moving mechanism to transport the cleaning device to the conveying device designated by the cleaning request in response to a cleaning request; instruct the cleaning mechanism to perform a cleaning operation on the conveying device designated by the cleaning request.

In accordance with another aspect of the present application, there is provided a controller associated with a conveying device of a passenger conveyor system, the conveying device being an escalator or a moving walkway, the controller comprising: a wireless communication unit configured to communicate with one or more self-mobility cleaning devices; a memory; a processor coupled with the memory and the wireless communication unit; and a computer program stored on the memory and capable of running on the processor, the operation of which results in the following operations: causing the conveying device to enter a cleaning mode when a standby message from the cleaning device or a first sensor sensing signal indicating that the cleaning device arrives at an entrance or exit of the conveying device is received via the wireless communication unit; and causing the conveying device to exit the cleaning mode when a cleaning completion message from the cleaning device or a second sensor sensing signal indicating that the cleaning device leaves the entrance or the exit of the conveying device is received via the wireless communication unit.

In accordance with another aspect of the present application, there is provided a cleaning method for a passenger conveyor system, the passenger conveyor system comprising one or more conveying devices, the conveying device being an escalator or a moving walkway, the method comprising: A. causing a self-mobility cleaning device to move, in response to a cleaning request, to an entrance or exit of the conveying device designated by the cleaning request; and B. causing the cleaning device to perform a cleaning operation on the designated conveying device.

### BRIEF DESCRIPTION OF THE DRAWINGS

The above and/or other aspects and advantages of the present application will be clearer and more easily understood from the following description of various aspects in conjunction with the accompanying drawings, in which the same or similar elements are denoted by the same reference numerals. The accompanying drawings include:

FIG. 1 is a schematic block diagram of a cleaning system for a passenger conveyor system in accordance with some embodiments of the present application.

FIG. 2 is a schematic block diagram of a device that may be used to implement a cleaning device in the cleaning system shown in FIG. 1.

FIG. 3 is a schematic block diagram of a control device. The control device shown in FIG. 3 may be used to implement a controller in the cleaning system shown in FIG. 1.

FIG. 4 is a flowchart of a cleaning method for a passenger conveyor system in accordance with some other embodiments of the present application.

### DETAILED DESCRIPTION OF THE INVENTION

The present application is described more fully below with reference to the accompanying drawings, in which illustrative embodiments of the application are illustrated. However, the present application may be implemented in different forms and should not be construed as limited to the embodiments presented herein. The presented embodiments are intended to make the disclosure herein comprehensive and complete, so as to more comprehensively convey the protection scope of the application to those skilled in the art.

In this specification, terms such as “comprising” and “including” mean that in addition to units and steps that are directly and clearly stated in the specification and claims, the technical solution of the application does not exclude the presence of other units and steps that are not directly and clearly stated in the specification and claims.

Unless otherwise specified, terms such as “first” and “second” do not indicate the order of the units in terms of time, space, size, etc., but are merely used to distinguish the units.

In this specification, a mobile terminal refers to a variety of computing devices capable of being used on the move. Examples of mobile terminals include, but are not limited to, cell phones, laptops, tablets, wearable devices, personal digital assistants, and so on.

In this specification, “passenger conveyor system” refers to an automated passenger transportation system, which may comprise one or more conveying devices for transporting pedestrians over short distances or between different elevations. Examples of these conveying devices include, but are not limited to, escalators, moving walkways, and so on. It will become apparent from the subsequent description that the present application may be applicable to a variety of passenger conveyor systems, such as a passenger conveyor system comprising an escalator and a passenger conveyor system comprising a moving walkway.

As an example of a conveying device, an escalator substantially includes a truss extending between a lower station and an upper station, a plurality of sequentially connected steps or tread plates connected to a step chain and traveling through a closed loop path within the truss, and a drive system configured to drive the tread plates through the step chain so as to move the tread plates in a chosen direction at a desired speed under normal operating conditions.

The escalator further includes a controller in electronic communication with a drive motor. The controller may be located in a machine space of the escalator and is configured to control operation of the escalator. For example, the controller may provide a drive signal to the drive motor to control acceleration, deceleration, stopping, and the like of the tread plates through the step chain. The controller may be an electronic controller including a processor and an associated memory comprising computer-executable instructions that, when executed by the processor, cause the processor to perform various operations. The processor may be, but is not limited to, a single-processor or multi-processor system of any of a wide variety of possible architectures, including field-programmable gate array (FPGA), central processing unit (CPU), application-specific integrated circuit (ASIC), digital signal processor (DSP) or graphics processing unit (GPU) hardware arranged homogeneously or heterogeneously. The memory may be, but is not limited to, random access memory (RAM), read-only memory (ROM), or other electronic, optical, magnetic, or any other computer-readable medium.

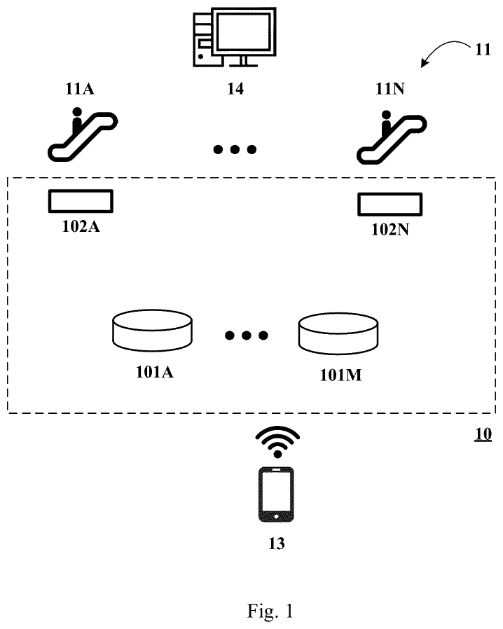

FIG. 1 is a schematic block diagram of a cleaning system for a passenger conveyor system in accordance with some embodiments of the present application. Referring to FIG. 1, exemplarily, a passenger conveyor system 11 includes a plurality of conveying devices 11A to 11N, which may be escalators or moving walkways.

As shown in FIG. 1, the illustrated cleaning system 10 comprises one or more cleaning devices 101A-101M having a self-mobility or self-walking capability. Optionally, the cleaning system 10 further comprises controllers 102A-102N, wherein the cleaning devices and the controllers may communicate wirelessly, and each of the controllers 102A-102N is associated with one of the conveying devices 11A to 11N, i.e., each controller controls the operation of the associated conveying device. It is noted that each controller may be integrated into the conveying device with which it is associated, but this arrangement is not necessary. In some examples, the controller and the associated conveying device may be spatially discrete.

Exemplarily, the cleaning devices 101A-101M may take the form of a sweeping robot. Self-mobility capability as described herein refers to the capability that the cleaning device can move to a designated location (e.g., an upper or lower station of an escalator) with the aid of its own moving mechanism based on internally-generated or externally-sourced control command.

Each of the cleaning devices 101A-101M may be configured to perform at least the following operations: moving, in response to a cleaning request, to an entrance or exit of the conveying device designated by the cleaning request and performing a cleaning operation on the designated conveying device.

In some embodiments, the cleaning request may be generated locally at the cleaning devices 101A-101M. Optionally, the cleaning device may generate the cleaning request in response to a user command (e.g., a control command entered by the user via a human-machine interface set up on the cleaning device or via a wireless device); alternatively, the user may preset a time for generating the cleaning request within the cleaning device to cause the cleaning device to generate the cleaning request locally within the set time.

In some embodiments, the cleaning devices 101A-101M may receive the cleaning request via an external device (e.g., a mobile terminal 13, a console 12 of the passenger conveyor system 11, or the controllers 102A-102N).

Optionally, in various embodiments, the cleaning request may be generated based on historical operational data (e.g., a time period of operation of the conveying device, a duration of operation of the cleaning device over a period of time, etc.) of the cleaning device or the conveying device.

Optionally, in some embodiments, the designated conveying device is caused to enter the cleaning mode by sending a standby message to the controller associated with the designated conveying device after the cleaning device arrives at a designated location and before starting to perform the cleaning operation. The entrance or the exit of the conveying device described herein may be, for example, the upper or lower station of the escalator, or the start or end of the moving walkway, and the like. Optionally, the standby message contains a device identification of the designated conveying device.

The cleaning mode described herein refers to a mode of operation of the conveying device adapted to perform the cleaning operation on the conveying device (e.g. a cover of the escalator) by the cleaning device. In some embodiments, in this mode of operation, the pedals of the conveying device move at a set speed, including a speed of zero, and an operation indicator of the conveying device indicates that the conveying device is in an out-of-service state.

Optionally, each of the cleaning devices 101A-101M may also be configured to perform the following operations: after completing a cleaning task or a cleaning operation, causing the designated conveying device to exit the cleaning mode by sending a cleaning completion message to the controller associated with the designated conveying device.

Alternatively, each of the cleaning devices 101A-101M may also be configured to perform the following operations: determining whether the conveying device at a current location of the cleaning device is the conveying device designated by the cleaning request by scanning a device identification attached to or near the conveying device, and sending the standby message containing the designated conveying device's device identification upon confirming that the conveying device at the current location is the conveying device designated by the cleaning request.

In some embodiments, each of the controllers 102A-102N may be configured to perform at least the following operations: causing the conveying device associated with the respective controller to enter the cleaning mode in response to an event triggering entry into the cleaning mode; and causing the conveying device associated with the respective controller to exit the cleaning mode in response to an event triggering exit from the cleaning mode.

The event triggering entry into the cleaning mode may comprise other types of events in addition to the standby message received by the controller from the cleaning device. Optionally, a sensor (e.g. a light sensor such as a visible light sensor or an infrared sensor) may be provided at the entrance or the exit of the conveying device, which, when the cleaning device arrives at the entrance or the exit of the conveying device, will result in the generation of a corresponding sensing signal S1 on the sensor, the generation of which may be taken as the event triggering entry into the cleaning mode. In one example, a plurality of light sensors may be provided at different heights at the entrance or the exit of the designated conveying device, and whether the cleaning device is located at the entrance or the exit of the conveying device may be determined based on a combination of obscured states of light directed to these sensors, and thus when the sensing signal S1 comprises sensing signals from a plurality of light sensors, it may be used for determining the presence of the cleaning device. Specifically, the height of the cleaning device is low, so that when it is located at the entrance or the exit of the conveying device, the light sensor SEN1 located at the lower height will no longer receive the light, while the light sensor SEN2 located at the higher height will still receive the light, whereby it may be determined that the cleaning device is located at the entrance or the exit of the conveying device based on the combination of a state in which the light sensor SEN1 does not receive the light with a state in which the light sensor SEN2 receives the light. Since a combination of sensor signals at different heights is utilized to determine the presence of the cleaning device, the cleaning device can be accurately distinguished from other objects, such as passengers.

The event triggering exit from the cleaning mode may comprise other types of events in addition to the cleaning completion message received by the controller from the cleaning device. Optionally, a sensor (e.g. a light sensor such as a visible light sensor or an infrared sensor) may be provided at the entrance or the exit of the conveying device, which, when the cleaning device leaves the entrance or the exit of the conveying device, will be triggered to generate a corresponding sensing signal S2, the generation of which may be taken as the event triggering exit from the cleaning mode. In one example, a light sensor SEN3 may be provided at the entrance or the exit of the designated conveying device to generate the sensing signal S2, and when the cleaning device leaves the entrance or the exit of the conveying device, the light directed to the sensor SEN3 will be changed from an obscured state to an unobscured state, whereby the leaving of the cleaning device may be determined based on the above-described change indicated by the sensing signal S2. It should be noted that the light sensor SEN3 may be a sensor different from the light sensor SEN1 that is provided at a lower height, or may be realized using the light sensor SEN1.

In the embodiment shown in FIG. 1, the communication between the cleaning device and the external device may be based on various wireless communication protocols, for example, including but not limited to, a Bluetooth communication protocol, a ZigBee communication protocol, a WiFi communication protocol, and so on.

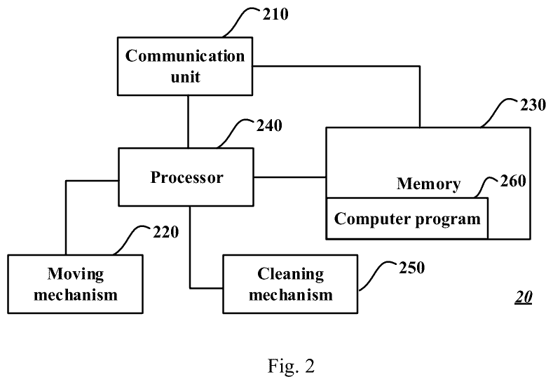

FIG. 2 is a schematic block diagram of a device that may be used to implement the cleaning device in the cleaning system shown in FIG. 1.

Referring to FIG. 2, a device 20 shown includes a wireless communication unit 210, a moving mechanism 220 (which for example comprises wheels), a memory 230 (for example a non-volatile memory such as a flash memory, a ROM, a hard drive, a disk, an optical disc, etc.), a processor 240, and a cleaning mechanism 250.

The wireless communication unit 210 serves as a communication interface configured to establish a communication connection between the device 20 and an external device (e.g., a mobile terminal, the controllers 102A-102N of FIG. 1, and a console of a passenger conveyor system, etc.).

The memory 230 stores a computer program 260 executable by the processor 240. optionally, the memory 230 may also store a map of the area in which the passenger conveyor system is located.

The processor 240 is coupled with the wireless communication unit 210, the moving mechanism 220, the memory 230, and the cleaning mechanism 250, and is configured to run the computer program 260 stored on the memory 230 to perform various operations, including for example, but not limited to: generating a cleaning request on a timed basis; in response to the generated cleaning request or a cleaning request received via the wireless communication unit 210, instructing the moving mechanism 220 to transport the device 20 to the conveying device designated by the cleaning request (exemplarily, it is assumed herein that the designated conveying device is 11A and, accordingly, that the associated controller is 101A); causing the conveying device to enter the cleaning mode by sending a standby message via the wireless communication unit 210 to the controller 101A associated with the designated conveying device 11A; instructing the cleaning mechanism to perform the cleaning operation on the conveying device (e.g., instructing the cleaning mechanism to perform the cleaning operation after determining that the conveying device enters the cleaning mode, in a manner that includes, for example, but is not limited to, receiving a notification that the conveying device is in the cleaning mode from the associated controller, etc.); causing the conveying device 11A to exit the cleaning mode by sending a cleaning completion message to the controller 101A via the wireless communication unit 210, etc.

Optionally, the processor 240 may implement the sending of the standby message by running the computer program 260 stored on the memory 230 in the following manner: instructing an optical scanning device (not shown) equipped on the device 20 to scan for a device identification attached to or near the conveying device, and thereafter determining, based on the scanned identification, whether the conveying device at a current location of the device 20 is the conveying device 11A designated by the cleaning request, and upon determining that the conveying device at the current location is the conveying device designated by the cleaning request, the standby message is sent to the conveying device via the wireless communication unit 210. Optionally, the standby message contains the device identification of the designated conveying device.

In some embodiments, the movement of the moving mechanism 220 is controlled by a user control command (e.g. from the user's mobile terminal). For example, the user may input commands such as forward, backward, left turn, right turn, and turn in place on the mobile device, and the moving mechanism 220 may receive these control commands via the wireless communication unit 210 and thereby realize the corresponding movement.

In other embodiments, the moving mechanism 220 may generate a path to reach the designated conveying device based on navigational information, such as a map of the area in which the passenger conveyor system is located and the location or number of the designated conveying device. Exemplarily, the location or number of the designated conveying device is included in the cleaning request, and the map may be pre-stored in the memory 230 or obtained from an external device (e.g., a mobile terminal, the controllers 102A-102N of FIG. 1, and a console of the passenger conveyor system, etc.).

Optionally, the moving mechanism 220 has an environmental sensing capability so as to be able to avoid obstacles in the path of travel.

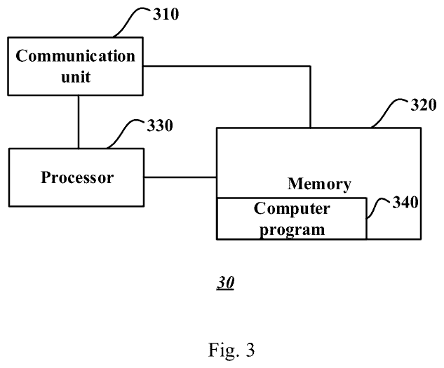

FIG. 3 is a schematic block diagram of a control device. The control device shown in FIG. 3 may be used to implement the controller in the cleaning system shown in FIG. 1.

As shown in FIG. 3, a control device 30 comprises a wireless communication unit 310, a memory 320 (for example a non-volatile memory such as a flash memory, a ROM, a hard drive, a disk, an optical disc, etc.), and a processor 330.

The wireless communication unit 310 serves as a communication interface configured to establish a communication connection between the control device 30 and an external device (e.g., a mobile terminal, the cleaning devices 101A-101M of FIG. 1, and a console of a passenger conveyor system, etc.).

The memory 320 stores a computer program 340 executable by the processor 330. The processor 330 is coupled with the wireless communication unit 310 and the memory 320, and configured to run the computer program 340 stored on the memory 320 to perform various operations, including for example, but not limited to: causing the conveying device to enter the cleaning mode when a standby message from the cleaning device or a sensing signal from a sensor (a signal S1 indicating that the cleaning device arrives at the entrance or the exit of the conveying device) is received via the wireless communication unit 310; causing the conveying device to exit the cleaning mode when a cleaning completion message from the cleaning device or a sensing signal from the sensor (e.g., a signal S2 indicating that the cleaning device leaves the entrance or the exit of the conveying device) is received via the wireless communication unit 310.

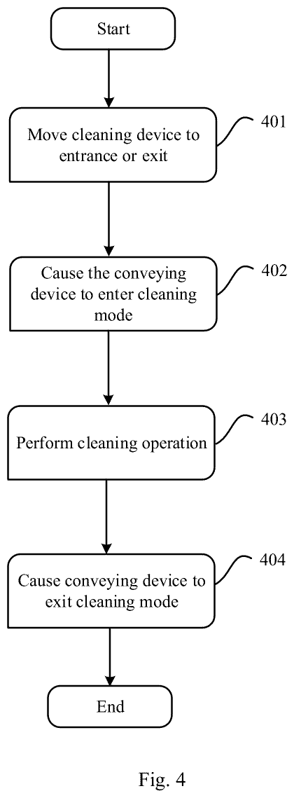

FIG. 4 is a flowchart of a cleaning method for a passenger conveyor system in accordance with some other embodiments of the present application. Exemplarily, the method described below is realized with the cleaning system shown in FIG. 1.

The method shown in FIG. 4 begins at step 401. In step 401, one of the self-mobility cleaning devices 101A-101M (exemplarily, assumed to be the cleaning device 101A) is caused to move, in response to a cleaning request, to an entrance or exit of the conveying device 11A designated by the cleaning request. As described above, the cleaning request may be generated locally at the cleaning device or received from a mobile terminal or a controller (exemplarily, assumed to be the controller 102A) associated with the conveying device (exemplarily, assumed to be the conveying device 11A).

The movement of the cleaning device may be controlled using the methods described above, such as based on user control commands (e.g., from a user's mobile terminal) or navigational information (e.g., a map of the area in which the passenger conveyor system is located and the location of the designated conveying device).

After completing step 401, the process shown goes to step 402. In step 402, the controller 102A associated with the designated conveying device 11A is caused to cause the conveying device 11A to enter the cleaning mode in response to an event triggering entry into the cleaning mode.

Optionally, the conveying device 11A may be caused to enter the cleaning mode by causing the cleaning device 101A to send the standby message to the controller 102A upon arrival at the entrance or the exit of the designated conveying device 11A, prompting the controller 102A to generate a control command to cause the conveying device 11A to enter the cleaning mode.

Alternatively, it is also possible to cause the controller 102A to generate a control command to cause the conveying device 11A to enter the cleaning mode by causing a sensor provided near the entrance or the exit of the conveying device 11A to generate a sensing signal (e.g., a signal S1 indicating that the cleaning device 101A arrives at the entrance or the exit of the conveying device 11A).

In step 402, the cleaning device may implement the sending of the standby message using the methods described above: scanning a device identification attached to or near the conveying device using an optical scanning device equipped on the cleaning device, and sending the standby message to the conveying device when the conveying device indicated by the scanned identification is the conveying device designated by the cleaning request.

After completing step 402, the process shown goes to step 403. In step 403, the cleaning device 101A performs a cleaning operation on the designated conveying device 11A (e.g., an escalator cover) using its cleaning mechanism.

Optionally, in step 403, the cleaning device determines whether the conveying device enters the cleaning mode, and upon determining that the conveying device enters the cleaning mode, the processor of the cleaning device instructs the cleaning mechanism to perform the cleaning operation. Alternatively, it may be determined that the conveying device has entered the cleaning mode on the basis of a notification or message received from the associated controller that the conveying device is in the cleaning mode.

Then proceed to step 404. In step 404, the controller 102A associated with the designated conveying device 11A is caused to cause the designated conveying device to exit the cleaning mode in response to an event triggering exit from the cleaning mode.

Optionally, the conveying device 11A may be caused to exit the cleaning mode by causing the cleaning device 101A to send a cleaning completion message to the controller 102A upon completion of the cleaning operation thereof, prompting the controller 102A to generate a control command to cause the conveying device 11A to exit the cleaning mode.

Alternatively, it is also possible to cause the controller 102A to generate a control command to cause the conveying device 11A to exit the cleaning mode by causing a sensor provided near the entrance or the exit of the conveying device 11A to generate a sensing signal (e.g., a signal S2 indicating that the cleaning device 101A leaves the entrance or the exit of the conveying device 11A).

Those skilled in the art will appreciate that the various illustrative logical blocks, modules, circuits, and algorithm steps described herein may be implemented as electronic hardware, computer software, or combinations of both.

To demonstrate this interchangeability between the hardware and software, various illustrative components, blocks, modules, circuits, and steps have been described above generally in terms of their functionality. Whether such functionality is implemented in hardware or software depends on the particular application and design constraints imposed on the overall system. Those skilled in the art may implement the described functionality in changing ways for the particular application. However, such implementation decisions should not be interpreted as causing a departure from the scope of the present application.

Although only a few of the specific embodiments of the present application have been described, those skilled in the art will recognize that the present application may be embodied in many other forms without departing from the spirit and scope thereof. Accordingly, the examples and implementations shown are to be regarded as illustrative and not restrictive, and various modifications and substitutions may be covered by the application without departing from the spirit and scope of the application as defined by the appended claims.

The embodiments and examples presented herein are provided to best illustrate embodiments in accordance with the present technology and its particular application, and to thereby enable those skilled in the art to implement and use the present application. However, those skilled in the art will appreciate that the above description and examples are provided for convenience of illustration and example only. The presented description is not intended to cover every aspect of the application or to limit the application to the precise form disclosed.

What is claimed is:

1. A cleaning system for a passenger conveyor system, the passenger conveyor system comprising one or more conveying devices, the conveying device being an escalator or a moving walkway, the cleaning system comprising:
a self-mobility cleaning device configured to move, in response to a cleaning request, to an entrance or exit of the conveying device designated by the cleaning request and to perform a cleaning operation on the designated conveying device.

2. The cleaning system of claim 1, wherein further comprising a controller associated with the conveying device.

3. The cleaning system of claim 1, wherein the cleaning request is generated by the cleaning device or from one of a mobile terminal, a controller associated with the conveying device, and a console of the passenger conveyor system.

4. The cleaning system of claim 1, wherein the cleaning request is generated in response to a user command or generated based on historical operational data of the cleaning device or the conveying device.

5. The cleaning system of claim 2, wherein the cleaning device is further configured to instruct the controller to cause the designated conveying device to enter a cleaning mode after moving to the entrance or the exit of the conveying device designated by the cleaning request and before performing the cleaning operation on the designated conveying device, and to instruct the controller to cause the designated conveying device to exit the cleaning mode after completing the cleaning operation on the designated conveying device.

6. The cleaning system of claim 2, wherein the controller associated with the designated conveying device is configured to cause the designated conveying device to enter the cleaning mode in response to an event triggering entry into the cleaning mode, and to cause the designated conveying device to exit the cleaning mode in response to an event triggering exit from the cleaning mode.

7. The cleaning system of claim 1, wherein the cleaning device is a sweeping robot.

8. The cleaning system of claim 5, wherein in the cleaning mode, a pedal of the conveying device moves at a set speed or an operation indicator of the conveying device indicates that the conveying device is in an out-of-service state.

9. The cleaning system of claim 6, wherein the event triggering entry into the cleaning mode comprises the controller receiving a standby message sent by the cleaning device or a first sensor sensing signal triggered by the cleaning device arriving at the entrance or the exit of the designated conveying device, and the event triggering exit from the cleaning mode comprises the controller receiving a cleaning completion message sent by the cleaning device or a second sensor sensing signal triggered by the cleaning device leaving the entrance or the exit of the designated conveying device.

10. The cleaning system of claim 9, wherein the first sensor sensing signal is indicative of a combination of obscured states of light at different heights at the entrance or the exit of the designated conveying device, and the second sensor sensing signal is indicative of a change in the light from an obscured state to an unobscured state at the entrance or the exit of the designated conveying device.

11. The cleaning system of claim 3, wherein the cleaning device comprises:
a first wireless communication unit configured to communicate with one of the mobile terminal, the controller and the console;
a moving mechanism;
a first processor coupled with the first wireless communication unit, configured to:
instruct the moving mechanism to transport the cleaning device to the conveying device designated by the cleaning request in response to the cleaning request generated by the first processor or received via the first wireless communication unit;
cause the designated conveying device to enter the cleaning mode by sending a standby message to the controller associated with the designated conveying device via the first wireless communication unit before performing the cleaning operation on the designated conveying device;
cause the designated conveying device to exit the cleaning mode by sending a cleaning completion message to the controller associated with the designated conveying device via the first wireless communication unit after completing the cleaning operation on the designated conveying device.

12. The cleaning system of claim 11, wherein a movement of the moving mechanism is based on navigation information or user control command.

13. The cleaning system of claim 11, wherein the operation of the first processor sending the standby message comprises:
determining whether the conveying device at a current location of the cleaning device is the conveying device designated by the cleaning request by scanning a device identification attached to or near the conveying device;
sending the standby message if it is the conveying device designated by the cleaning request, the standby message containing the device identification of the designated conveying device.

14. The cleaning system of claim 4, wherein the controller comprises:
a second wireless communication unit configured to communicate with the cleaning device;
a memory;
a second processor coupled with the memory and the second wireless communication unit; and
a computer program stored on the memory and capable of running on the second processor, the operation of which results in the following operations:
causing the conveying device to enter the cleaning mode when the standby message or the first sensor sensing signal is received via the second wireless communication unit; and
causing the conveying device to exit the cleaning mode when the cleaning completion message or the second sensor sensing signal is received via the second wireless communication unit.

15. A cleaning device for a passenger conveyor system, the passenger conveyor system comprising one or more conveying devices, the conveying device being an escalator or a moving walkway, the cleaning device comprising:
a wireless communication unit;
a moving mechanism;
a cleaning mechanism;
a processor coupled with the wireless communication unit, configured to:
instruct the moving mechanism to transport the cleaning device to the conveying device designated by the cleaning request in response to a cleaning request;
instruct the cleaning mechanism to perform a cleaning operation on the conveying device designated by the cleaning request.

16. A controller associated with a conveying device of a passenger conveyor system, the conveying device being an escalator or a moving walkway, the controller comprising:
a wireless communication unit configured to communicate with one or more self-mobility cleaning devices;
a memory;
a processor coupled with the memory and the wireless communication unit; and
a computer program stored on the memory and capable of running on the processor, the operation of which results in the following operations:
causing the conveying device to enter a cleaning mode when a standby message from the cleaning device or a first sensor sensing signal indicating that the cleaning device arrives at an entrance or exit of the conveying device is received via the wireless communication unit; and
causing the conveying device to exit the cleaning mode when a cleaning completion message from the cleaning device or a second sensor sensing signal indicating that the cleaning device leaves the entrance or the exit of the conveying device is received via the wireless communication unit.

17. A cleaning method for a passenger conveyor system, the passenger conveyor system comprising one or more conveying devices, the conveying device being an escalator or a moving walkway, the method comprising:
A. causing a self-mobility cleaning device to move, in response to a cleaning request, to an entrance or exit of the conveying device designated by the cleaning request; and
B. causing the cleaning device to perform a cleaning operation on the designated conveying device.

18. The cleaning method of claim 17, wherein the cleaning request is generated by the cleaning device or from one of a mobile terminal, a controller associated with the conveying device, and a console of the passenger conveyor system.

19. The cleaning method of claim 17, wherein the cleaning request is generated in response to a user command or generated based on historical operational data of the cleaning device or the conveying device.

20. The cleaning method of claim 18, wherein causing a controller associated with the designated conveying device to cause the designated conveying device to enter the cleaning mode in response to an event triggering entry into the cleaning mode after completing step A and before performing step B, and causing the controller to cause the designated conveying device to exit the cleaning mode in response to an event triggering exit from the cleaning mode after completing step B.

21. The cleaning method of claim 17, wherein the cleaning device is implemented by using a sweeping robot.

22. The cleaning method of claim 20, wherein in the cleaning mode, a pedal of the conveying device moves at a set speed or an operation indicator of the conveying device indicates that the conveying device is in an out-of-service state.

23. The cleaning method of claim 20, wherein the event triggering entry into the cleaning mode comprises the controller receiving a standby message sent by the cleaning device or a first sensor sensing signal triggered by the cleaning device arriving at the entrance or the exit of the designated conveying device, and the event triggering exit from the cleaning mode comprises the controller receiving a cleaning completion message sent by the cleaning device or a second sensor sensing signal triggered by the cleaning device leaving the entrance or the exit of the designated conveying device.

24. The cleaning method of claim 23, wherein the first sensor sensing signal is indicative of a combination of obscured states of light at different heights at the entrance or the exit of the designated conveying device, and the second sensor sensing signal is indicative of a change in the light from an obscured state to an unobscured state at the entrance or the exit of the designated conveying device.

25. The cleaning method of claim 17, wherein a movement of the cleaning device is based on navigation information or user control command.

26. The cleaning method of claim 20, wherein the standby message is sent in the following manner:
causing the cleaning device to scan a device identification attached to or near the conveying device to determine whether the conveying device at a current location of the cleaning device is the conveying device designated by the cleaning request;
causing the cleaning device to send the standby message to the controller if it is the conveying device designated by the cleaning request, the standby message containing the device identification of the designated conveying device.
